(19) United States
(12) Patent Application Publication
(10) Pub. No.: US 2009/0313293 A1
(43) Pub. Date: Dec. 17, 2009

(54) METHOD TO EMBEDDING SVG CONTENT INTO AN ISO BASE MEDIA FILE FORMAT FOR PROGRESSIVE DOWNLOADING AND STREAMING OF RICH MEDIA CONTENT

(75) Inventors: Vidya Setlur, Cupertino, CA (US); Suresh Chitturi, Plano, TX (US); Tolga Capin, Ankara (TR); Michael Ingrassia, San Jose, CA (US); Daidi Zhong, Helsinki (FI); Miska Hannuksela, Ruutana (FI)

Correspondence Address: FOLEY & LARDNER LLP, P.O. BOX 80278, SAN DIEGO, CA, 92138-0278, US

(73) Assignee: Nokia Corporation

(21) Appl. No.: 12/545,005

(22) Filed: Aug. 20, 2009

Related U.S. Application Data
(63) Continuation of application No. 11/515,133, filed on Sep. 1, 2006.
(60) Provisional application No. 60/713,303, filed on Sep. 1, 2005.

(51) Int. Cl. G06F 17/30; G06F 15/16

(52) U.S. Cl. 707/102; 709/236; 709/246; 709/231; 707/E17.005

(57) ABSTRACT

A method of embedding vector graphics content such as SVG into the 3GPP ISO Base Media File Format for progressive downloading or streaming of live rich media content over MMS/PSS/MBMS services. The method of the present invention allows the file format to be used for the packaging of rich media content including graphics, video, text and images; enables streaming servers to generate RTP packets; and enables clients to realize, play, or render rich media content.

### CROSS-REFERENCE TO RELATED PATENT APPLICATIONS

This application is a Continuation of U.S. application Ser. No. 11/515,133, filed Sep. 1, 2006, incorporated herein by reference in its entirety, which claims priority from Provisional Application U.S. Application 60/713,303, filed Sep. 1, 2005, incorporated herein by reference in its entirety.

### FIELD OF THE INVENTION

The present invention relates generally to the embedding of content for progressive downloading and stream. More particularly, the present invention relates to the embedding of SVG content for the progressive downloading and streaming of rich media content.

### BACKGROUND OF THE INVENTION

Rich media content is generally referred to content that is graphically rich and contains compound or multiple media, including graphics, text, video and audio, and is preferably delivered through a single interface. Rich media dynamically changes over time and can respond to user interaction. The streaming of rich media content is becoming increasingly important for delivering visually rich content for real-time content, especially within the MBMS/PSS service architecture.

Multimedia Broadcast/Multicast Service (MBMS) streaming services facilitate the resource-efficient delivery of popular real-time content to multiple receivers in a 3G mobile environment. Instead of using different point-to-point (PtP) bearers to deliver the same content to different mobile devices, a single point-to-multipoint (PtM) bearer is used to deliver the same content to different mobiles in a given cell. The streamed content may comprise video, audio, Scalable Vector Graphics (SVG), timed-text and other supported media. The content may be prerecorded or generated from a live feed.

There are several existing solutions for representing rich media, particularly in the web services domain. SVGT 1.2 is a language for describing two-dimensional graphics in XML. SVG allows for three types of graphics objects: (1) vector graphic shapes (e.g., paths consisting of straight lines and curves); (2) multimedia such as raster images, audio and video; and (3) text. SVG drawings can be interactive (using a DOM event model) and dynamic. Animations can be defined and triggered either declaratively (i.e., by embedding SVG animation elements in SVG content) or via scripting. Sophisticated applications of SVG are possible through the use of a supplemental scripting language which accesses the SVG Micro Document Object Model (uDOM), which provides complete access to all elements, attributes and properties. A rich set of event handlers can be assigned to any SVG graphical object. Because of its compatibility and leveraging of other Web standards such as CDF, features such as scripting can be performed on XHTML and SVG elements simultaneously within the same Web page.

The Synchronized Multimedia Integration Language (SMIL) 2.0 enables the simple authoring of interactive audiovisual presentations. SMIL is typically used for “rich media”/multimedia presentations which integrate streaming audio and video with images, text or any other media type.

The Compound Documents Format (CDF) working group is currently attempting to combine separate component languages (e.g. XML-based languages, elements and attributes from separate vocabularies) such XHTML, SVG, MathML, and SMIL, with a focus on user interface markups. When combining user interface markups, specific problems must be resolved that are not addressed by the individual markups specifications, such as the propagation of events across markups, the combination of rendering or the user interaction model with a combined document. This work is divided in phases and two technical solutions: combining by reference and by inclusion.

None of the above solutions or mechanisms specify how rich media content that includes SVG content can be embedded into an ISO Base Media File Format for progressive downloading and streaming purposes.

Until recently, applications for mobile devices were text-based with limited interactivity. However, as more wireless devices are equipped with color displays and more advanced graphics-rendering libraries, consumers are increasingly demanding a rich media experience from all of their wireless applications. A real-time rich media content streaming service is therefore extremely desirable for mobile terminals, especially in the area of MBMS, PSS, and MMS services.

SVG is designed to describe resolution-independent two-dimensional vector graphics (and often embeds other media such as raster graphics, audio, video, etc.), and allows for interactivity using the event model and animation concepts borrowed from SMIL. It also allows for infinite zoomability and enhances the power of user interfaces on mobile devices. As a result, SVG is gaining importance and is becoming one of the core elements of multimedia presentation, especially for rich media services such as MobileTV, live updates of traffic information, weather, news, etc. SVG is XML-based, allowing more transparent integration with other existing web technologies. SSVG has been endorsed by the W3C as a recommendation and Adobe as a preferred data format.

The ISO Base Media File Format, defined by 3GPP, is a new worldwide standard for the creation, delivery and playback of multimedia over third generation, high-speed wireless networks. This standard seeks to provide the uniform delivery of rich multimedia over newly evolved, broadband mobile networks (third generation networks) to the latest multimedia-enabled wireless devices. The current file format is only defined for audio, video and timed text. Therefore, with the growing importance of SVG, it has become important to incorporate SVG along with traditional media (video, audio, etc.) into the ISO Base Media File Format in order to enhance and deliver true rich media content, particularly over mobile devices. This implies that rich media streaming servers and clients could support this enhanced ISO Base Media File Format for content delivery for either progressive download or streaming solutions.

Currently, there are no existing solutions for embedding graphics media in SVG into the 3GPP ISO Base Media File Format for progressive download or streaming of rich media content. PCT Publication No. WO2005/039131 introduced a method for transmitting a multimedia presentation comprising several media objects within a container format. U.S. Published Patent Application No. 2005/0102371 discussed a method for arranging streaming or downloading a streamable file comprising meta-data and media-data over a network between a server and a client with at least part of the meta-data of the file being transmitted to the client. However, the current solutions for vector graphics in 3GPP are limited only to downloading and playing, otherwise known as HTTP streaming.

### SUMMARY OF THE INVENTION

The present invention provides for a method of embedding vector graphics content such as SVG into the 3GPP ISO Base Media File Format for progressive downloading or streaming of live rich media content over MMS/PSS/MBMS services. The method of the present invention allows the file format to be used for the packaging of rich media content (graphics, video, text, images, etc.), enable streaming servers to generate RTP packets, and enables clients to realize, play, or render rich media content.

The present invention extends the ISO Base Media File Format to accommodate SVG content. There has been no previous solution for including both frame based media, such as video, with time based SVG. The ISO Base Media File Format is the new mobile phone file format for the creation, delivery and playback of multimedia over third generation, high-speed wireless networks. The inclusion of SVG facilitates greater leverage for offering rich media services to 3G mobile devices.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system within which the present invention may be implemented;

FIG. 2 is a perspective view of a mobile telephone that can be used in the implementation of the present invention;

FIG. 3 is a schematic representation of the telephone circuitry of the mobile telephone of FIG. 2;

FIG. 4 is a flow chart showing a process for offering rich media services from a server to a client device in an ISO Base Media File context; and

FIG. 5 is a flow chart illustrating a process for generating a container file and sending a file based on the container file in accordance with a file delivery hint track feature in an ISO Base Media File context.

### DETAILED DESCRIPTION OF THE PREFERRED EMBODIMENTS

The present invention provides for a method of embedding vector graphics content such as SVG into the 3GPP ISO Base Media File Format for progressive downloading or streaming of live rich media content over MMS/PSS/MBMS services. The method of the present invention allows the file format to be used for the packaging of rich media content (graphics, video, text, images, etc.), enable streaming servers to generate RTP packets, and enables clients to realize, play, or render rich media content.

There are several use cases for rich media services. Several of these use cases are as follows.

Preview of long cartoon animations—This service allows an end-user to progressively download small portions of each animation before deciding which animation he or she wishes to view in its entirety.

Interactive Mobile TV services—This service enables a deterministic rendering and behavior of rich-media content including audio-video content, text, graphics, images, and TV and radio channels, all together in an end-user interface. The service must provide convenient navigation thru content in a single application or service and must allow synchronized interaction locally or remotely for purposes such as voting and personalization (e.g.: related menu or sub-menu, advertising and content in function of the end-user profile or service subscription). This use case is described in four steps corresponding to four services and sub-services available in an iTV mobile service: (1) mosaic menu: TV Channel landscape; (2) electronic program guide and triggering of related iTV service; (3) iTV service; and (4) personalized menu “sport news.”

Live enterprise data feed—This service includes stock tickers that provide the streaming of real-time quotes, live intra-day charts with technical indicators, news monitoring, weather alerts, charts, business updates, etc.

Live chat—The live chat service can be incorporated within a web cam, video channel or a rich-media blog service. End-users can register, save their surname and exchange messages. Messages appear dynamically in the live chat service, along with rich-media data provided by the end-user. The chat service can be either private or public in one or more multiple channels at the same time. End users are dynamically alerted of new messages from other users. Dynamic updates of messages within the service occur without reloading a complete page.

Karaoke—This service displays a music TV channel or video clip catalog, along with the speech of a song with fluid-like animation on the text characters for singing (e.g. smooth color transition of fonts, scrolling of text). The end user can download a song of his or her choice, along with the complete animation, by selecting an interactive button.

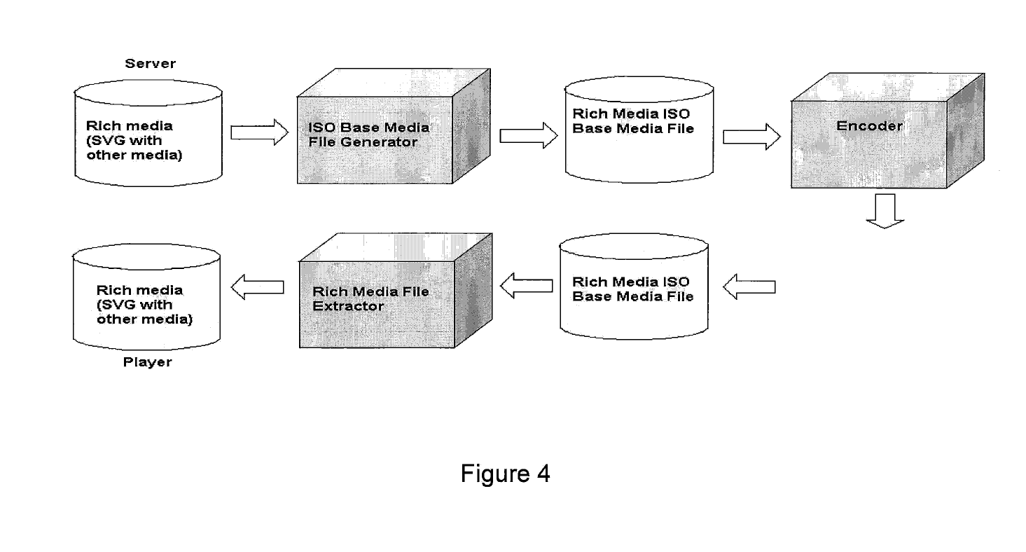

FIG. 4 is a representation of a process for offering rich media services from a server 100 to a client device 110 in an ISO Base Media File context. Rich media (SVG with other media) is provided to an ISO Base Media File Generator 120, which is used to create a Rich Media ISO Base Media File 130. This item is then passed through an encoder 140 and is subsequently decoded by a decoder 150. The Rich Media ISO Base Media File 130 is then extracted by a Rich Media File Extractor 160 and can then be used by the client device 110.

A first implementation of the present invention comprises three steps: (1) Defining a new SVG media track in the ISO Base Media File Format; (2) Specifying hint track information within the ISO Base Media File Format to facilitate the RTP packetization of the SVG samples; and (3) Specifying an optional Shadow Sync Sample Table to facilitate random access points for seek operations.

In the ISO Base Media File Format, the overall presentation is referred to as a movie and is logically divided into tracks. Each track represents a timed sequence of media (e.g. frames in video, scene and scene updates in SVG). Each timed unit in each track is referred to as a sample. Each track has one or more sample descriptions, where each sample in the track is tied to the corresponding sample description by reference. All of the data within this file format is encapsulated in a hierarchy of boxes. A box is an object-oriented building block defined by a unique type identifier and length. All data is contained in boxes; there is no other data within the file. This includes any initial signature required by the specific file format.

Table 1 shows the box hierarchy of the ISO Base Media File Format. The ordering and guidelines of these boxes conform to the ISO/IEC 15444-12:2005 specifications as disclosed at www.jpeg.org/jpeg2000/j2kpart12.html. The implementation details discussed herein provide additional box definitions and descriptors required to include SVG media in the file format. All other boxes in Table 1 conform to their definitions and syntax as described in the specification. As the data in the ISO Base Media File Format can occur at several levels including presentation, track and sample levels, it needs to be grouped and integrated into a single presentation. In Table 1, the boxes newly defined in this document are highlighted in bold.

TABLE 1

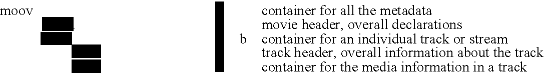

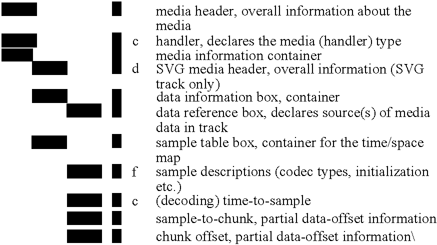

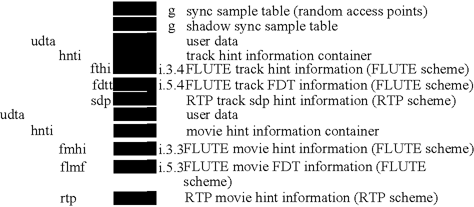

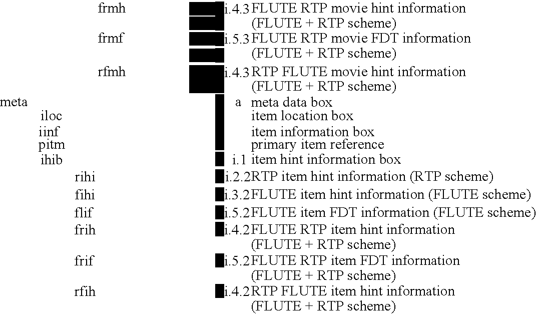

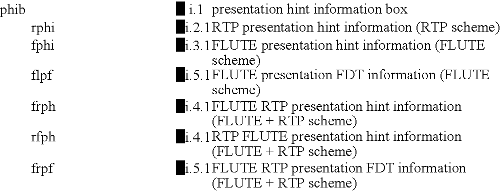

A first implementation of the present invention involves defining box syntaxes for SVG media. The various box syntaxes are as follows:

Media Data Box and Meta Box. In conventional systems, all media data (audio, video, timed text, raster images, etc.) is either contained in individual files or in different Media Data Boxes (‘mdat’) within the same file or a combination of the two. Both the ‘moov’ box and the ‘meta’ box can be used to save the metadata. The container of the ‘meta’ box can be a file, the ‘moov’ box or the ‘trak’ box. According to the 3GPP file format (3GPP TS 26.244), a 3GP file with an extended presentation includes a Meta Box (‘meta’) at the top level of the file.

When the primary data is in XML format and it is desired that the XML be stored directly in the meta-box, the XML boxes (‘xml’ and ‘bxml’) under the ‘meta’ hierarchy can be used, depending whether the data is pure XML or binary XML respectively. Because SVG is a type of XML data, the SVG media data can be stored in individual files, different ‘mdat’ within the same file, or in the XML boxes (‘xml’ or ‘bxml’) or a combination of the three.

Track Box (trak). A track box contains a single track of a presentation. Each track is independent of each other, carrying its own temporal and spatial information. Each Track Box is associated with its own Media Box. As a default, the presentation addresses all tracks of the Movie Box. However, it is possible to address individual media tracks in the Movie Box by referring to their track IDs. Individual tracks are addressed by listing their numbers, e.g. “#box=moov;track_ID=1,3”.

Handler Reference Box. A new SVG handler is introduced herein. This handler defines a handler type ‘svxm’ and a name ‘image/svg+xml’.

Media Information Header Box. The SVG Media Header Box contains general presentation information for SVG media. The definition and syntax of this box is as follows:

| | |
|---|---|
| Box Type: | ‘smhb’ |
| Container: | Media Information Box (‘minf’) |
| Mandatory: | Yes |
| Quantity: | Exactly one |

aligned (8) class SVGMediaHeaderBox extends FullBox(‘smhb’,
version = 0, 0) {
string version_profile;
string base_profile;
unsigned int(8) sdid_threshold;
}

The “version_profile” specifies the profile of SVG used, whether SVGT1.1, or SVGT1.2. The “base-profile” describes the minimum SVG language profile that is believed to be necessary to correctly render the content (SVG Tiny or SVG Basic). The “sdid_threshold” specifies the threshold of the Sample Description Index Field (SDID). The SDID is an 8-bits index used to identify the sample descriptions (SD) to help decode the payload. The maximum value for SDID is 255, and the default threshold value for static and dynamic SDIDs is 127.

Time to Sample Boxes. The Decoding Time to Sample Box (stts) describes how the decoding time to sample information must be computed for scene and scene updates. The Decoding Time to Sample Box contains a compact version of a table that allows indexing from decoding time to sample number. Each entry in the table gives the number of consecutive samples with the same time delta, and the delta of those samples. By adding the deltas, a complete time-to-sample map may be built. The sample entries are ordered by decoding time stamps; therefore the deltas are all non-negative. For reference, the ISO Base Media File Format syntax for the TimeToSampleBox is as follows:

```
aligned(8) class TimeToSampleBox extends FullBox(’stts’,
version = 0, 0) {
    unsigned int(32)  entry_count;
    int  i;
    for (i=0; i < entry_count; i++) {
        unsigned int(32) sample_count;
        unsigned int(32) sample_delta;
    }
}
```

In this case, the “entry_count” is an integer that gives the number of entries in the following table. The “sample_count” is an integer that counts the number of consecutive samples that have the given duration. The “sample_delta” is an integer that gives the delta of these samples in the time-scale of the media. For example, one can examine a situation where there is one scene, with a start time of 0th time units. In this situation, there can also be three scene updates, with start times of a 5th time unit, a 10th time unit, and a 15th time unit. In this case, there are four total entries. In this situation, the decoding time to sample table entries are as follows:

entry_count=4

TABLE 2

| | | | | |
|---|---|---|---|---|
| sample_count | 1 | 1 | 1 | 1 |
| sample_delta | 0 | 5 | 5 | 5 |

Alternatively, Table 2 can be represented as follows, because the deltas for the scene updates are identical:

entry_count=4

TABLE 3

| | | |
|---|---|---|
| sample_count | 1 | 3 |
| sample_delta | 0 | 5 |

Another example where the time intervals are unequal is as follows. One scene can have a start time of a 0^{th} time unit. In this example, there are four scene updates, with start times of a 2^{nd} time unit, a 7^{th} time unit, a 12^{th} time unit and a 15^{th} time unit. In this situation, the Decoding time to Sample Table entries are as follows.

entry_count=5

TABLE 4

| | | | | | |
|---|---|---|---|---|---|
| sample_count | 1 | 1 | 1 | 1 | 1 |
| sample_delta | 0 | 2 | 5 | 5 | 3 |

This can be shown alternatively as:

TABLE 5

| | | | | |
|---|---|---|---|---|
| sample_count | 1 | 1 | 2 | 1 |
| sample_delta | 0 | 2 | 5 | 3 |

Several items should be noted in such an arrangement. Scenes and scene updates do NOT overlap temporally. The ‘time unit’ is calculated based upon the ‘timescale’ defined in the Media Header Box (‘mdhd’). Additionally, the ‘timescale’ requires sufficient resolution to ensure each decoding time is an integer. Lastly, different tracks may have different timescales. If the SVG media is the container format for all other media including audio and video, then the timescale of presentation is the timescale of the primary SVG media. However, if SVG media coexists with other media, then the presentation timescale is not less than the maximum timescale among all the media in the presentation.

Sample Description Box. Under the Sample Description Box (stsd) in the ISO Base Media File Format, a SVGSampleEntry is defined below. It defines the sample description format to represent SVG samples within this scene track. It contains all of the necessary information for decoding of SVG samples.

```
class SVGSampleEntry( ) extends SampleEntry (‘ssvg’) { //’ssvg’ ->
                                        unique type identifier for
                                        //SVG Sample
  unsigned int(16)  pre_defined = 0;
  const unsigned int(16)  reserved = 0;
  unsigned int(8) type;
  string  content_encoding;
  string  text_encoding;
  unsigned int(8) content_script_type;
    unsigned int(16) format_list[ ];
}
```

The “type” specifies whether this sample represents a scene or a scene update. The “content_encoding” is a null terminated string with possible values being ‘none,’ ‘bin_xml,’ ‘gzip,’ ‘compress,’ ‘deflate.’ This specification is according to Section 3.5 of RFC 2616, which can be found at www.w3.org/Protocols/rfc2616/rfc2616-sec3.html#sec3.5). The “text_encoding” is a null terminated string with possible values taken from the ‘name’ or ‘alias’ field (depending on the application) in the IANA specification (which can be found at www.iana.org/assignments/character-sets) such as US-ASCII, BS_{—}4730, etc. The “content_script_type” identifies the default scripting language for the given sample. This attribute sets the default scripting language for all of the instances of script in the document. The value “content_type” specifies a media type. If scripting is not enabled, then the value for this field is 0. The default value is “ecmascript” with value 1. The “format_list” lists all of the media formats that appear in the current sample. Externally embedded media is not considered in this case.

Media can be embedded in SVG as <xlink:href=“ski.avi” volume=“0.8” type=“video/x-msvideo” x=“10” y=“170”> or <xlink:href=“1.ogg” volume=“0.7” type=“audio/vorbis” begin=“mybutton.click” repeatCount=“3”>.

The format_list indicates the format numbers of the internally linked embedded media within the corresponding SVG sample. The format list is an array where the format number of the SVG sample is stored in the first position, followed by the format numbers of the other embedded media. For example, if the SDP of an SVG presentation is:

m=svg+xml 12345 RTP/AVP 96
a=rtpmap:96 X-SVG+XML/100000
a=fmtp:96 sdid-threshold=63;version_provile=“1.2”;base_profile=“1”
....
m=video 49234 RTP/AVP 98 99 100 101
a=rtpmap:98 h263-2000/90000
....

If one specific SVG sample contains the video media with format numbers of 99, 100, then the format_list of this sample sequentially contains values: 96, 99, 100. It should be noted that some of the parameters specified in the SVGSampleEntry box can be defined within the SVG file itself, and the ISO Base Media File generator can parse the XML-like SVG content to obtain information about the sample. However, for flexibility in design, this information is provided as fields within the SVGSampleEntry box.

Sync Sample Box and Shadow Sync Sample Box. The Sync Sample Box and Shadow Sync Sample Box are defined in ISO Base Media File Format (ISO/IEC 15444-12, 2005). The Sync Sample Box provides a compact marking of the random access points within the stream. If the sync sample box is not present, every sample is a random access point. The shadow sync table provides an optional set of sync samples that can be used when seeking or for similar purposes. In normal forward play, they are ignored. The ShadowSyncSample replaces, not augments, the sample that it shadows. The shadow sync sample is treated as if it occurred at the time of the sample it shadows, having the duration of the sample it shadows. As an example, the following SVG sample sequence is considered:

S SU SU SU S SU SU SU S S SU SU SU

| | sample_index | | | | | | | | | | | | |
|---|---|---|---|---|---|---|---|---|---|---|---|---|---|
| | 0 | 1 | 2 | 3 | 4 | 5 | 6 | 7 | 8 | 9 | 10 | 11 | 12 |
| Samples | S | SU | SU | SU | S | SU | SU | SU | S | S | SU | SU | SU |

In this situation, each SVG scene (S) is a random access point. All of the SVG Scenes are capable (but not necessary) of being a Sync Sample. If the samples with indices 0, 4 and 8 are considered to be sync samples, then the Sync Sample List is as follows:

| | | | |
|---|---|---|---|
| entry_index | 0 | 1 | 2 |
| sync_sample_number | 0 | 4 | 8 |

The shadow sync samples are normally placed in an area of the track that is not presented during normal play (i.e., a portion which is edited out by an edit list), although this is not a requirement. The shadow sync samples are ignored during normal forward play. A shadowed_sample_number can be assigned to either a non-sync SVG scene or an SVG scene update. One mapping example of each (sync_sample_number, shadowed_sample_number) pair in the ShadowSyncSampleBox is as follows.

| | S | SU | SU | SU | S | SU | SU | SU | S | S | SU | SU | SU |
|---|---|---|---|---|---|---|---|---|---|---|---|---|---|
| sample_index | 0 | 1 | 2 | 3 | 4 | 5 | 6 | 7 | 8 | 9 | 10 | 11 | 12 |
| shadowed_sample_number | | 0 | 1 | 2 | | 3 | 4 | 5 | | 6 | 7 | 8 | 9 |
| sync_sample_number | | 0 | 0 | 0 | | 4 | 4 | 4 | | 8 | 8 | 8 | 8 |

It should be noted that, even though the sample with index 9 is an SVG scene in this example, it is not considered to be a sync sample. Rather, a shadowed_{—sample}_number can be assigned to this scene.

Specifying Transport Schemes and Corresponding Session Description Formats. SVG supports media elements similar to Synchronized Multimedia Integration Language (SMIL) media elements. All of the embedded media can be divided into two parts—dynamic and static media. Dynamic media or real time media elements define their own timelines within their time container. For example,

<audio xlink:href=”1.ogg” volume=”0.7” type=”audio/vorbis”
begin=”mybutton.click” repeatCount=”3” />
<video xlink:href=”ski.avi” volume=”.8” type=”video/x-msvideo” x=”10”
y=”170”/>

Static media, such as images, are embedded in SVG using the ‘image’ element, such as:

<image x=“200” y=“200” width=“100px” height=“100px”
xlink:href=“myimage.png”>

SVG can also embed other SVG documents, which in turn can embed yet more SVG documents through nesting. The animation element specifies an external embedded SVG document or an SVG document fragment providing synchronized animated vector graphics. Like the video element, the animation element is a graphical object with size determined by its x, y, width and height attributes. For example:

<animation begin=“1” dur=“3” repeatCount=“1.5” fill=“freeze” x=“100”
y=“100” xlink:href=“myIcon.svg”/>

Similarly, the media in SVG can be internally or externally referenced. While the above examples are internally referenced, the following example shows externally referenced media:

```
<animate attributeName=”xlink:href”
values=”http://www.example.com/images/1.png;
                http://www.example.com/images/2.png;
                        http://www.example.com/images/3.png”
                begin=”15s” dur=”30s” />
```

The embedded media elements can be linked through internal or external URLs in the SVG content. In this case, internal URLS refer to file paths within the ISO Base Media File itself. External URLS refer to file paths outside the ISO Base Media File. In this invention, transport mechanisms are described only for internally embedded media. Session Description Protocol (SDP) is correspondingly specified for internally embedded media and scene description.

The transport mechanisms discussed herein are only provided for internally embedded media, while the receiver can request externally embedded dynamic media from the external streaming server. Therefore, the Session Description information defined below is only applied to internally embedded media.

For internally embedded media, both the dynamic media and static media can be transported by FLUTE (file delivery over unidirectional transport). However, only the dynamic media among them can be transported by RTP. The static media can be transported by RTP only when it has its own RTP payload format. The static embedded media files (e.g., images) can be explicitly transmitted by (1) sending them to the user equipment (UE) in advance via a FLUTE session; (2) sending the static media to each client on a point-to-point bearer before the streaming session, in a manner similar to the way security keys are sent to clients prior to an MBMS session; (3) having a parallel FLUTE transmission session independent of the RTP transmission session, if enough radio resources are available; or (4) having nonparallel transmission sessions to transmit all of the data due to the limited radio resources. Each transmission session contains either FLUTE data or RTP data. In addition, an RTP SDP format is specified to transport SVG scene descriptions and dynamic media, and a FLUTE SDP format is specified to transport SVG scene description, dynamic and static media.

Session Description Protocol is a common practical format to specify the session description. It is used below to specify the session description of each transport protocol. RTP packets can be used to transport the scene description and dynamic internally embedded media. For dynamic embedded media (e.g., video) in SVG, the scene description can address the files in a format similar to:

<video xlink:href=“video1.263”.... >
<video xlink:href=“video2.263”.... >

These two embedded media can be addressed by the Item Information Box (‘iinf’) according to the item_ID or item_name. For example, if the media are referred by the Item Information Box as item_ID=2 and item_ID=4 respectively, and the corresponding item_names are item_name=“video1.263” and item_name=“video2.263”, the corresponding SDP format can be defined as:

m=video 49234 RTP/AVP 98 99
a=rtpmap:98 h263-2000/90000
a=fmtp:98 item_ID=2;profile=3;level=10
a=rtpmap:99 h263-2000/90000
a=fmtp:99 item_name=“video2.263”; profile=3;level=10

The URL forms for meta boxes have been defined in the ISO Base Media File Format (ISO/IEC 15444-12 2005, section 8.44.7), in which the item_ID and item_name are used to address the items. The item_ID and item_name can be used to address both an external and internal dynamic media file present in another 3GPP file, since all of the necessary information is available in the Item Location Box and Item Information Box. The ItemLocationBox provides the location of this dynamic embedded media, and the ItemInfoBox provides the ‘content_type’ of this media. The ‘content_type’ is a MIME type. From that field, the decoder can know which type the media is. In addition, the extended presentation profile of 3GPP requires that there must be an ItemInfoBox and an ItemLocationBox in the meta box, and such meta box is a root-level meta box.

In another example, the current 3GPP file contains two video tracks with the same format. The scene description uses the following text to address the tracks:

<video xlinik:href=“#box=moov;track_ID=3”...>
<video xlinik:href=“#box=moov;track_ID=5”...>

The corresponding SDP format can be defined as:

m=video 49234 RTP/AVP 98 99
a=rtpmap:98 h263-2000/90000
a=fmtp:98 box=moov;track_ID=3;profile=3;level=10
a=rtpmap:99 h263-2000/90000
a=fmtp:99 box=moov;track_ID=5;profile=3;level=10

FLUTE packets can be used to transport the scene description, dynamic internally embedded media and static internally embedded media. The URLs of the internally embedded media are indicated in the File Delivery Table (FDT) inside of the FLUTE session, rather than in the Session Description. The syntax of the SDP description for FLUTE has been defined in the Internet-Draft: SDP Descriptors for FLUTE, which can be found at www.ietf.org/internet-drafts/draft-mehta-rmt-flute-sdp-02.txt.

Boxes for Storing SDP Information. In the current ISO Base Media File Format, SDP information is stored in a set of boxes within user-data boxes at both the movie and track levels using the moviehintinformation box and trackhintinformation box respectively. The moviehintinformation box contains the session description information that covers the data addressed by the current movie. It is contained in the User Data Box under “Movie Box.” The trackhintinformation box contains the session description information that covers the data addressed by the current track. It is contained in the User Data Box under “Track Box.” However, as the hintinformationbox (‘hnti’) is defined only at the movie and track levels, there is no such information in place in the original ISO Base Media File Format for situations where the client requests the server to transmit data of a specific item during interaction or if audio, video, image files and XML data in the XMLBox need to be transmitted together as a presentation. To address this problem, two additional hint information containers are defined here: ‘itemhintinformationbox’ and ‘presentationhintinformationbox.’

The itemhintinformation box contains the session description information that covers the data addressed by all the items. It is contained in the Meta Box, and this Meta Box is at the top level of the file structure. The syntax is as follows:

| aligned(8) class itemhintinformationbox extends box (‘ihib‘) { | |
|---|---|
| unsigned int(16) | entry_count; |
| for (i=0; i<entry_count; i++) { | |
| unsigned int(16) | item_ID; |
| string | item_name; |
| Box | container_box; |
| } | |
| } | |

The itemhintinformationbox is stored in the ‘other boxes’ field in the Meta Box at the file level. The “item_ID” contains the ID of the item for which the hint information is specified. It has the same value as the corresponding item in the ItemLocationBox and ItemInfoBox. The “item_name” is a null terminated string in UTF-8 characters containing a symbolic name of the item. It has the same value as the corresponding item in the ItemInfoBox. It may be an empty string when item_ID is available. The “container_box” is the container box containing the session description information of a given item, such as SDP. The “entry_count” provides a count of the number of entries in the following array.

The presentationhintinformation box contains the session description information that covers the data addressed during the whole presentation. It may contain any data addressed by the items or tracks, as well as the data in the XMLBox. It is contained in the User Data Box, and this User Data Box is at the top level of the file structure. The syntax is as follows:

aligned(8) class presentationhintinformationbox extends box (‘phib’){ }

Various description formats may be used for RTP. In these boxes, the ‘sdptext’ field is correctly formatted as a series of lines, each terminated by <crlf>, as required by SDP (section 10.4 of ISO/IEC 15444-12:2005). This case arises for the transmission of SVG scene and scene updates and dynamic embedded media. In the current ISO Base Media File Format, SDP Boxes are defined for RTP only at the movie and track level. Two additional boxes are therefore defined at the presentation and item levels. First, a presentation level hint information container is defined within the ‘phib’ box and is dedicated for RTP transport. The syntax is as follows:

```
aligned(8) class rtppresentationhintinformation extends box(‘rphi‘) {
  uint(32) descriptionformat = ‘sdp ‘;
  char sdptext[ ];
}
```

The media resources are identified by using ‘item_ID’, ‘item_name’, ‘box’ or ‘track_ID’, as in, for example:

....
m=video 49234 RTP/AVP 98 99 100
a=rtpmap:98 h263-2000/90000
a=fmtp:98 box=moov;track_ID=3;profile=3;level=10
a=rtpmap:99 h263-2000/90000
a=fmtp:99 item_ID=2;profile=3;level=10
a=rtpmap:100 h263-2000/90000
a=fmtp:100 item_name=“3gpfile.3gp”;box=moov;track_ID=5;
profile=3;level=10
...

Second, an item level hint information container is defined within the ‘ihib’ box and is dedicated for RTP transport:

```
aligned(8) class rtpitemhintinformation extends box(‘rihi‘) {
  uint(32) descriptionformat = ‘sdp ‘;
  char sdptext[ ];
}
```

There may be various description formats for FLUTE. Only SDP is defined in current document. The sdptext is correctly formatted as a series of lines, each terminated by <crlf>, as required by SDP. This case arises for the transmission of SVG scene and scene updates and static embedded media. As the current ISO Base Media File Format does not have SDP container boxes for FLUTE at any level (presentation, movie, track, item, etc.), boxes for all these four levels are defined as shown.

A presentation level hint information container is defined within ‘phib’ box, dedicated for FLUTE. This can be used when all the content in “current presentation” is sent via FLUTE. The syntax is as follows.

```
aligned(8) class flutepresentationhintinformation extends box(‘fphi‘) {
  uint(32) descriptionformat = ‘sdp ‘;
  char sdptext[ ];
}
```

An item level hint information container is defined within ‘ihib’ box, dedicated for FLUTE. This can be used when all the content in “current item” is sent via FLUTE. The syntax is as follows.

```
aligned(8) class fluteitemhintinformation extends box(‘fihi‘) {
  uint(32) descriptionformat = ‘sdp ‘;
  char sdptext[ ];
}
```

A movie level hint information container is defined within ‘hnti’ box, dedicated for FLUTE. This can be used when all the content in “current movie” is sent via FLUTE. The syntax is as follows.

aligned(8) class flutemoviehintinformation extends box(‘fmhi‘) {
uint(32) descriptionformat = ‘sdp ‘;
char sdptext[ ];
}

A track level hint information container is defined within ‘hnti’ box, dedicated for FLUTE. This can be used when all the content in current track is sent via FLUTE. The syntax is as follows.

```
aligned(8) class flutetrackhintinformation extends box(‘fthi‘) {
  uint(32) descriptionformat = ‘sdp ‘;
  char sdptext[ ];
}
```

The FLUTE+RTP transport system may be used when SVG media contains both static and dynamic embedded media. The static media is transmitted via FLUTE, and the dynamic media is transmitted via RTP. Correspondingly, the SDP information for FLUTE and RTP can be saved in the following boxes. They can be further combined by the application.

Presentation SDP Information (The following two boxes are contained in the ‘phib’ box.)

```
aligned(8) class flutertppresentationhintinformation extends box(‘frph‘) {
  uint(32) descriptionformat = ‘sdp ‘;
  char  sdptext[ ];
}
aligned(8) class rtpflutepresentationhintinformation extends box(‘rfph‘) {
  uint(32) descriptionformat = ‘sdp ‘;
  char sdptext[ ];
}
```

Item SDP Information. (The following two boxes are contained in the ‘ihib’ box.)

```
aligned(8) class flutertpitemhintinformation extends box(‘frih‘) {
  uint(32) descriptionformat = ‘sdp ‘;
  char  sdptext[ ];
}
aligned(8) class rtpfluteitemhintinformation extends box(‘rfih‘) {
  uint(32) descriptionformat = ‘sdp ‘;
  char sdptext[ ];
}
```

Movie SDP Information. (The following two boxes are contained in the movie level ‘hnti’ box.)

```
aligned(8) class flutertpmoviehintinformation extends box(‘frmh‘) {
  uint(32) descriptionformat = ‘sdp ‘;
  char  sdptext[ ];
}
aligned(8) class rtpflutemoviehintinformation extends box(‘rfmh‘) {
  uint(32) descriptionformat = ‘sdp ‘;
  char sdptext[ ];
}
```

The File Delivery Table (FDT) provides a mechanism for describing various attributes associated with files that are to be delivered within the file delivery session. Logically, the FDT is a set of file description entries for files to be delivered in the session. Each file description entry must include the Transport Object Identifier (TOI) for the file that it describes and the Uniform Resource Identifier (URI) identifying the file. Each file delivery session must have an FDT that is local to the given session. Within the file delivery session, the FDT is delivered as FDT Instances. An FDT Instance contains one or more file description entries of the FDT. FDT boxes are defined and used herein to store the data of FDT instances. FDT boxes are defined for the four levels—presentation, movie, track and item as shown below.

Two presentation-level FDT data containers are defined within the ‘phib’ box, dedicated for FLUTE and FLUTE+RTP transport schemes respectively. These containers are defined as follows:

```
aligned(8) class flutepresentationfdtinformation extends box(‘flpf‘) {
unsigned int(32)  fdt_instance_count;
for (i=0; i< fdt_instance_count; i++) {
  char fdttext[ ];
}
}
aligned(8) class flutertppresentationfdtinformation extends box(‘frpf‘) {
unsigned int(32)  fdt_instance_count;
for (i=0; i< fdt_instance_count; i++) {
  char fdttext[ ];
}
}
```

The Content-Location of embedded media resources may be referred by using the URL forms defined in Section 8.44.7 in ISO/IEC 15444-12:2005. The ‘item_ID’, ‘item_name’, ‘box’, ‘track_ID’, ‘#’ and ‘*’ may be used to indicate the URL. For example:

...
<File
Content-Location=“3gpfile.3gp#item_name=tree.html*branch1”
TOI=“2”
Content-Type=“text/html”/>
...

Two item-level FDT data containers are defined within ‘ihib’ box, dedicated for FLUTE and FLUTE+RTP transport schemes respectively. These containers are defined as follows:

```
aligned(8) class fluteitemfdtinformation extends box(‘flif‘) {
unsigned int(32)  fdt_instance_count;
for (i=0; i< fdt_instance_count; i++) {
    char fdttext[ ];
}
}
aligned(8) class flutertpitemfdtinformation extends box(‘frif‘) {
unsigned int(32)  fdt_instance_count;
for (i=0; i< fdt_instance_count; i++) {
    char fdttext[ ];
}
}
```

Two movie-level FDT data containers are defined within movie level ‘hnti’ box, dedicated for FLUTE and FLUTE+RTP transport schemes respectively. The two containers are defined as follows:

```
aligned(8) class flutemoviefdtinformation extends box(‘flmf‘) {
unsigned int(32)  fdt_instance_count;
for (i=0; i< fdt_instance_count; i++) {
    char fdttext[ ];
}
}
aligned(8) class flutertpmoviefdtinformation extends box(‘frmf‘) {
unsigned int(32)  fdt_instance_count;
for (i=0; i< fdt_instance_count; i++) {
    char fdttext[ ];
}
}
```

A track level FDT data container is defined within ‘hnti’ box, dedicated for FLUTE. This can be used when all the content in current track is sent via FLUTE. The container is defined as follows:

aligned(8) class flutetrackfdtinformation extends box(‘fdtt’) {
char fdttext[ ];
}

Hint Track Information. The hint track structure is generalized to support hint samples in multiple data formats. The hint track sample contains any data needed to build the packet header of the correct type, and also contains a pointer to the block of data that belongs in the packet. Such data can comprise SVG, dynamic and static embedded media. Hint track samples are not part of the hint track box structure, although they are usually found in the same file. The hint track data reference box (‘dref’) and sample table box (‘stbl’) can be used to find the file specification and byte offset for a particular sample. Hint track sample data is byte-aligned and always in big-endian format.

During user interaction, the client may request the server to send the dynamic internally embedded media via RTP. The metadata of such media could be saved in items. The RTP hint track format, can be used to generate an RTP stream for one item. In order to allow for efficient generation of RTP packets from item, syntax for this type of constructor at the item level is defined as follows. The fields are based upon the format in ISO 15444-12:2005 section 10.3.2.

```
aligned(8) class RTPitemconstructor extends RTPconstructor(4) {
    unsigned int(16) item_ID;
    unsigned int(16) extent_index;
    unsigned int(64) data_offset;  //offset in byte within extent
    unsigned int(32) data_length;  //length in byte within extent
}
```

A new constructor is also defined to allow for the efficient generation of RTP packets from the XMLBox or BinaryXMLBox. A syntax for this constructor is as follows:

```
aligned(8) class RTPxmlboxconstructor extends RTPconstructor(5)
{
    unsigned int(64) data_offset;  //offset in byte within XMLBox or
BinaryXMLBox
    unsigned int(32) data_length;
    unsigned int(32) reserved;
}
```

Based on these constructor formats, a hint track can efficiently generate RTP packets for the data from the ‘mdat’ box, the XMLBox or embedded media files and make a RTP stream for the combination of all the data.

In order to facilitate the generation of FLUTE packets, the hint track format for FLUTE is defined below. Similar to the hierarchy of RTP hint track, the FluteHintSampleEntry and FLUTEsample are defined. In addition, related structures and constructors are also defined.

FLUTE hint tracks are hint tracks (media handler ‘hint’), with an entry-format in the sample description of ‘flut’. The FluteHintSampleEntry is contained in the SampleDescriptionBox (‘stsd’), with the following syntax:

```
class FluteHintSampleEntry( ) extends SampleEntry (‘flut‘) {
      uint(16)  hinttrackversion = 1;
      uint(16)  highestcompatibleversion = 1;
      uint(32)  maxpacketsize;
      box  additionaldata[ ];  //optional
}
```

The fields, “hinttrackversion,” “highestcompatibleversion” and “maxpacketsize” have the same interpretation as that in the “RtpHintSampleEntry” field described in section 10.2 of the ISO/IEC 15444-12:2005 specification. The additional data is a set of boxes from timescaleentry and timeoffset, which are referenced in ISO/IEC 15444-12:2005 section 10.2. These boxes are optional for FLUTE.

Each FLUTE sample in the hint track will generate one or more FLUTE packets. Compared to RTP samples, FLUTE samples do not have their own specific timestamps, but instead are sent sequentially. Considering the sample-delta saved in the TimeToSampleBox, if the FLUTE samples represent fragments of the embedded media or SVG content, then the sample-delta between the first sample of current media/SVG and the final sample of previous media/SVG has the same value as the difference between start-time of the scene/update to which the current and previous media/SVG belong. The sample-deltas for the rest of the successive samples in current media/SVG are zero. However, if a FLUTE sample represents an entire media or SVG content, then there will be no successive samples (containing the successive data from the same media/SVG) with deltas equal to zero following this FLUTE sample. Therefore, only one sample-delta is present for current FLUTE sample. Each sample contains two areas: the instructions to compose the packets, and any extra data needed when sending those packets (e.g. an encrypted version of the media data). It should be noted that the size of the sample is known from the sample size table.

```
aligned(8) class FLUTEsample {
      unsigned int(16)  packetcount;
      unsigned int(16)  reserved;
      FLUTEpacket packets[packetcount];
      byte  extradata[ ];  //optional
}
```

Each packet in the packet entry table has the following structure:

| aligned(8) class FLUTEpacket { | |
|---|---|
| FLUTEheader | flute_header; |
| unsigned int(16) | entrycount; |
| dataentry | constructors[entrycount]; |
| } | |

| aligned(8) class FLUTEheader | |
|---|---|
| { | |
| UDPheader | header; |
| LCTheader | lct_header; |
| variable | FEC_payload_ID; |
| } | |

The “flute_header” field contains the header for current FLUTE packet. The “entry_count” field is the count of following constructors, and the “constructors” field defines structures which are used to construct the FLUTE packets. The FEC_payload_ID is determined by the FEC Encoding ID that must be communicated in the Session Description. The ‘FEC_encoding_ID’ used below must be signalled in the session description.

The details of the following syntax are based on references Request for Comments (RFC) 3926, 3450 and 3451 of the Network Working Group:

```
class pseudoheader {
    unsigned int(32) source_address;
    unsigned int(32) destination_address;
    unsigned int(8) zero;
    unsigned int(8) protocol;
    unsigned int(16) UDP_length;
}
class UDPheader {
    pseudoheader pheader;
    unsigned int(16) source_port;
    unsigned int(16) destination_port;
    unsigned int(16) length;
    unsigned int(16) checksum;
}
class LCTheader {
    unsigned int(4) V_bits;
    unsigned int(2) C_bits;
    unsigned int(2) reserved;
    unsigned int(1) S_bit;
    unsigned int(2) O_bits;
    unsigned int(1) H_bit;
    unsigned int(1) T_bit;
    unsigned int(2) R_bit;
    unsigned int(2) A_bit;
    unsigned int(2) B_bit;
    unsigned int(8) header_length;
    unsigned int(8) codepoint
    unsigned int((C_bits+1)*32) congestion_control_information;
    unsigned int(S_bit*32 + H_bit*16) transport_session_identifier;
    unsigned int(O_bits*32 + H_bit*16) transport_object_identifier;
//For EXT_FDT, TOI=0
    if (T_bit == 1) {
        unsigned int(32) sender_current_time;
    }
    if (T_bit == 1) {
        unsigned int(32) expected_residual_time;
    }
    if (header_length > (32 + (C_bits+1)*32 + S_bit*32 +
H_bit*16 + O_bits*32 + H_bit*16) ) {
        LCTheaderextentions header_extention;
    }
}
class LCTheaderextentions {
    unsigned int(8) header_extention_type;  //192- EXT_FDT, 193-
EXT_CENC, 64- EXT_FTI
    if (header_extention_type <= 127) {
        unsigned int(8) header_extention_length;
    }
    if (header_extention_type == 64){
        unsigned int(48) transfer_length;
if ((FEC_encoding_ID == 0)||(FEC_encoding_ID == 128)||
(FEC_encoding_ID == 130)) {
            unsigned int(16) encoding_symbol_length;
            unsigned int(32) max_source_block_length;
        }
        else if ((FEC_encoding_ID >= 128)||
        (FEC_encoding_ID <= 255)) {
            unsigned int(16) FEC_instance_ID;
        }
        else if (FEC_encoding_ID == 129) {
            unsigned int(16) encoding_symbol_length;
            unsigned int(16) max_source_block_length;
            unsigned int(16) max_num_of_encoding_symbol;
        }
    }
    else if (header_extention_type == 192){
        unsigned int(4) version = 1;
        unsigned int(20) FDT_instance_ID;
    }
    else if (header_extention_type == 193){
        unsigned int(8) content_encoding_algorithm;
//ZLIB,DEFLATE,GZIP
        unsigned int(16) reserved = 0;
    }
    else {
        byte other_extentions_content[ ];
    }
}
```

There are various forms of the constructor. Each constructor is 16 bytes, in order to make iteration easier. The first byte is a union discriminator. This structure is based upon section 10.3.2 from ISO/IEC 15444-12:2005.

```
aligned(8) class FLUTEconstructor(type) {
    unsigned int(8) constructor_type = type;
}
aligned(8) class FLUTEnoopconstructor extends FLUTEconstructor(0)
{
    uint(8) pad[15];
}
aligned(8) class FLUTEimmediateconstructor extends
FLUTEconstructor(1)
{
    unsigned int(8) count;
    unsigned int(8) data[count];
    unsigned int(8) pad[14 − count];
}
aligned(8) class FLUTEsampleconstructor extends FLUTEconstructor(2)
{
    signed int(8)  trackrefindex;
    unsigned int(16) length;
    unsigned int(32) samplenumber;
    unsigned int(32) sampleoffset;
    unsigned int(16) bytesperblock = 1;
    unsigned int(16) samplesperblock = 1;
}
aligned(8) class FLUTEsampledescriptionconstructor extends
FLUTEconstructor(3)
{
    signed int(8)  trackrefindex;
    unsigned int(16) length;
    unsigned int(32) sampledescriptionindex;
    unsigned int(32) sampledescriptionoffset;
    unsigned int(32) reserved;
}
aligned(8) class FLUTEitemconstructor extends FLUTEconstructor(4)
{
    unsigned int(16) item_ID;
    unsigned int(16) extent_index;
    unsigned int(64) data_offset;  //offset in byte within extent
    unsigned int(32) data_length;  //length in byte within extent
}
aligned(8) class FLUTExmlboxconstructor extends FLUTEconstructor(5)
{
    unsigned int(64) data_offset;  //offset in byte within XMLBox or
BinaryXMLBox
    unsigned int(32) data_length;
    unsigned int(32) reserved;
}
```

FDT data is one part of the whole FLUTE data stream. This data is transmitted during the FLUTE session in the form of FLUTE packets. Therefore, a constructor is needed to map the FDT data to FLUTE packet. The syntax of the constructor is provided as follows:

```
aligned(8) class FLUTEfdtconstructor extends FLUTEconstructor(6)
{
  unsigned int(2) fdt_box;  //0-‘fdtp’, 1-‘fdtm’, 2-‘fdti’, 3-‘fdtt’
  if ((fdt_box==0)||(fdt_box==1) ||(fdt_box==2)) {
    unsigned int(30) instance_index;  //index of the FDT instance
    unsigned int(64) data_offset;  //offset in byte within the given
FDT instance
    unsigned int(32) data_length;  //length in byte within the given
FDT instance
  } else {
    unsigned int(64) data_offset;  //offset in byte within the given
FDT box
    unsigned int(32) data_length;  //length in byte within the given
FDT box
    bit  pad[30];  //padding bits
  }
}
```

In the case where both RTP and FLUTE packets are transmitted simultaneously during a presentation, both constructors for RTP and FLUTE are used. RTP packets are used to transmit the dynamic media and SVG content, while FLUTE packets are used to transmit the static media. A different hint mechanism is used for this case. Such a mechanism can combine all of the RTP and FLUTE samples in a correct time order. In order to facilitate the generation of FLUTE and RTP packets for a presentation, the hint track format for FLUTE+RTP is defined below. Similar to the hierarchy of the RTP and the FLUTE hint tracks, the FluteRtpHintSampleEntry and FLUTERTPsample are defined. In addition, the data in TimeToSampleBox gives the time information for each packet.

FLUTE+RTP hint tracks are hint tracks (media handler ‘hint’), with an entry-format in the sample description of “frhs.” FluteRtpHintSampleEntry is defined within the SampledDescriptionBox “stsd.”

```
class FluteRtpHintSampleEntry( ) extends SampleEntry (‘frhs‘) {
    uint(16) hinttrackversion = 1;
    uint(16) highestcompatibleversion = 1;
    uint(32) maxpacketsize;
    box  additionaldata[ ];
}
```

The hinttrackversion is currently 1; the highest compatible version field specifies the oldest version with which this track is backward compatible. The maxpacketsize indicates the size of the largest packet that this track will generate. The additional data is a set of boxes (‘tims’ and ‘tsro’), which are defined in the ISO Base Media File Format.

FLUTERTPSample is defined within the MediaDataBox (‘mdat’). This box contains multiple FLUTE samples, RTP samples, possible FDT and SDP information and any extra data. One FLUTERTPSample may contain FDT data, SDP data, a FLUTE sample, or a RTP sample. FLUTERTPSamples that contain FLUTE samples are used only to transmit the static media. Such media are always embedded in the Scene or Scene Update among the SVG presentation. Their start-times are the same as the start-time of Scene/Scene Update to which they belong. FLUTE samples do not have their own specific timestamps, but instead are sent sequentially, immediately after the RTP samples of the Scene/Scene Update to which they belong. Therefore, in the TimeToSampleBox, the sample-deltas of the FLUTERTPSample for static media are all set to zero. Their sequential order represents their sending-time order.

UE may have limited power and can support only one transmission session at any time instant, and the FLUTE sessions and RTP sessions need to be interleaved one by one. One session is started immediately after the other is finished. In this case, description_text1, description_text2 and description_text3 fields below are used to provide SDP and FDT information for each session.

```
aligned(8) class FLUTERTPSample {
    unit(2)  sample_type;
    unsigned int(6)  reserved;
    if (sample_type == 0) {
        char  fdttext[ ]; //FDT info for following samples
    }
    else if (sample_type == 1) {
        char  sdptext[ ]; //SDP info for following samples
    }
    else if (sample_type == 2) {
        FLUTEsample flute_sample;
    }
    else {
        RTPsample  rtp_sample;
    }
    byte extradata[ ];
```

Sample Group Description Box. In some coding systems, it is possible to randomly access into a stream and achieve correct decoding after having decoded a number of samples. This is known as a gradual refresh. In SVG, the encoder may encode a group of SVG samples (scenes and updates) between two random access points (SVG scenes) and having the same roll distance. An abstract class is defined for the SVG sequence within the SampleGroupDescriptionBox (sgpd). Such descriptive entries are needed to define or characterize the SVG sample group. The syntax is as follows:

// SVG sequence
abstract class SVGSampleGroupEntry (type) extends
SampleGroupDescriptionEntry
(type) {
}

Random Access Recovery Points. SVG samples for which the gradual refresh is possible are marked by being a member of this SVG group. An SVG roll-group is defined as that group of SVG samples having the same roll distance. The corresponding syntax is as follows:

class SVGRollRecoveryEntry( ) extends SVGSampleGroupEntry (’roll’) {
signed int(16) roll_distance;

A number of additional alternative implementations of the present invention are generally as follows: A second implementation is the same as the first implementation discussed above, but with the fields re-ordered.

A third implementation of the present invention is similar to the first implementation discussed above, except that the lengths of the fields are altered based upon application dependency. In particular, certain fields can be shorter or longer than the specified values.

A fourth implementation of the present invention is substantially identical to the first implementation discussed in detail above. However, in the fourth implementation, any suitable compression method for SVG may be used for the Sample Description Box.

In a fifth implementation of the present invention, the SVG version and base profiles can be updated based upon the newer versions and compliance of SVG.

A sixth implementation of the present invention is also similar to the first implementation discussed above. In this implementation, however, some or all of the parameters specified in the SVGSampleEntry box can be defined within the SVG file itself, and the ISO Base Media File generator can parse the XML-like SVG content to obtain information about the sample.

A seventh implementation of the present invention is also similar to the first implementation. However, in terms of Boxes for Storing SDP information, one may redefine the “hnti’ box at other levels, for example to contain presentation-level inor item-level session information.

An eighth implementation is also similar to the first implementation. However, for SDP Boxes for the RTP Transport Mechanism, SDP Boxes for the FLUTE Transport Mechanism, and SDP Boxes for the FLUTE+RTP Transport Mechanism, other description formats may be stored. In such a case, the ‘sdptext’ field will change accordingly.

In a ninth implementation, for FDT Boxes for FLUTE, the whole FDT data can be divided into instances, fragments or single file descriptions. However, ‘FDT instance’ is typically used in FLUTE transmission.

In a tenth implementation of the present invention, for FDT Boxes for FLUTE, a single ‘fdttext’ field can contain all of the FDT data. The application can then choose to either fragment this data for all levels or for files.

In an eleventh implementation of the present invention, for the Hint Track Format for RTP, the discriminator of RTPconstructor(4) and RTPconstructor(5) are interchangeable.

In a twelfth implementation of the present invention, for the Hint Track Format for RTP, the item_ID field can be replaced with item_name.

In a thirteenth implementation of the present invention, also for the Hint Track Format for RTP, the data_length field can be made to 64 bytes by removing the reserved field.

In a fourteenth implementation of the present invention, for the Hint Track Format for RTP, the data_length field can be made to 16 bytes and adjust reserved field to 64 bytes.

In a fifteenth implementation of the present invention, for the Hint Track Format for RTP, the hinttrackversion and highestcompatibleversion fields may have different values.

In a sixteenth implementation of the present invention, for the Hint Track Format for RTP, a minpacketsize field may be added in addition to the maxpacketsize field.

In a seventeenth implementation of the present invention, for the Hint Track Format for RTP, the packetcount field can be made to 32 bits by removing the reserved field.

In an eighteenth implementation of the present invention, for the Hint Track Format for RTP, the hierarchical structure of the different header boxes (e.g., the FLUTEheader, UDPheader, LCTheader, etc.) can be different.

In a nineteenth implementation of the present invention, for the Hint Track Format for RTP, the FLUTEfdtconstructor syntax can have separate field definitions for each FDT_box.

In a twentieth implementation of the present invention, for the Hint Track Format for RTP, the fluteitemconstructor may have item_id replaced by item_name.

In a twenty-first implementation of the present invention, for the Hint Track Format for RTP, the flutexmlboxconstructor can have the data_length field to be made to 64 bytes by removing the reserved field.

In a twenty-second implementation of the present invention, for the Hint Track Format for RTP, the flutexmlboxconstructor can have the data_length field to be made to 16 bytes and adjust reserved field to 64 bytes.

In a twenty-third implementation of the present invention, for the Hint Track Format for RTP, the FluteRtpHintSampleEntry can have the hinttrackversion and highestcompatibleversion fields to be of different values.

In a twenty-fourth implementation of the present invention, for the Hint Track Format for RTP, the FluteRtpHintSampleEntry can add a minpacketsize field in addition to the maxpacketsize field.

In a twenty-fifth implementation of the present invention, for the Hint Track Format for RTP, the FLUTERTPSample box can have separate field definitions for each sample_type.

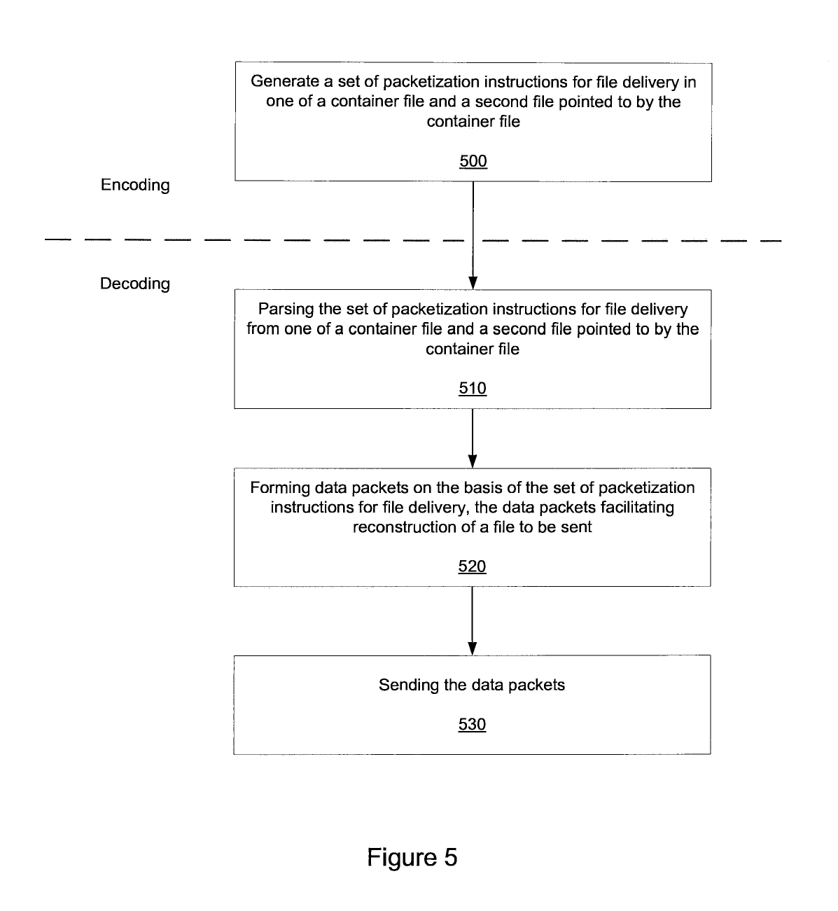

In a twenty-sixth implementation a container file comprising a set of packetization instructions for file delivery is generated, where the set of packetization instructions are utilized to form data packets facilitating reconstruction of a file. FIG. 5 illustrates this implementation for generating a container file, where at 500, a set of packetization instructions for file delivery is generated in a container file or in a second file that is pointed to/referenced by the container file. Hint tracks as specified in the ISO Base Media File Format can contain instructions to assist a streaming server in the formation of packets for transmission. A file/‘movie’/box that supports streaming includes information about its data units to stream that are included in additional tracks of the file referred to as the aforementioned hint tracks. Thus, the set of packetization instructions for file delivery are formatted as a hint track, and an object (e.g., file) is included in the container file or a third file point to/referenced by the container file. Additionally, the set of packetization instructions for file delivery includes a reference to the object. Moreover, the reference to the object can be realized as a constructor within a hint sample of the hint track.

Upon undergoing encoding and decoding processes as described earlier, the set of packetization instructions for file delivery are parsed from the container file/second file pointed to or referenced by the container file at 510. At 520, data packets can be formed on the basis of the set of packetization instructions for file delivery, the data packets facilitating reconstruction of a file to be sent. At 530, the data packets are sent.

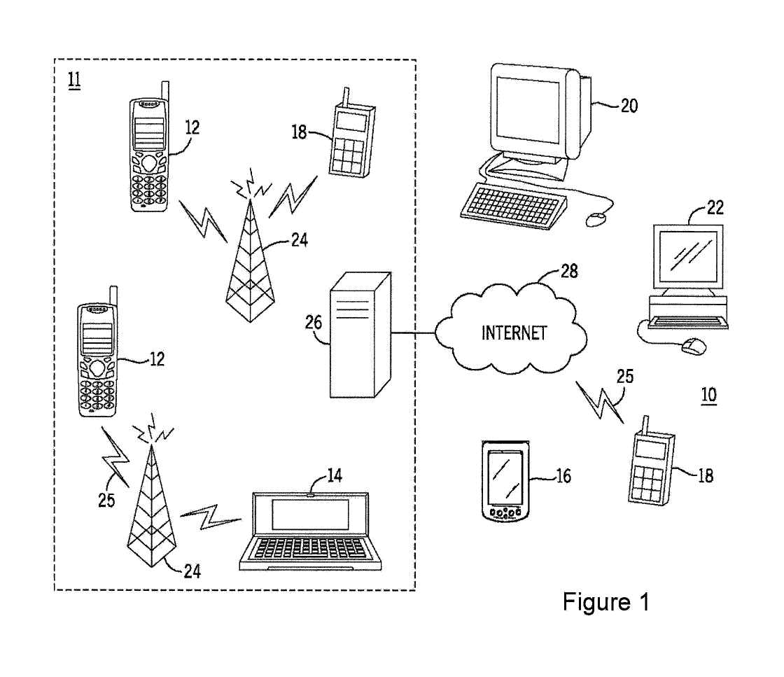

FIG. 1 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

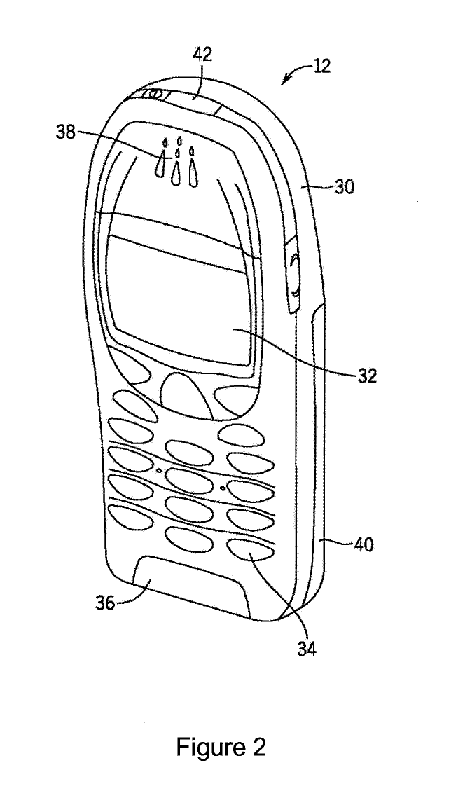

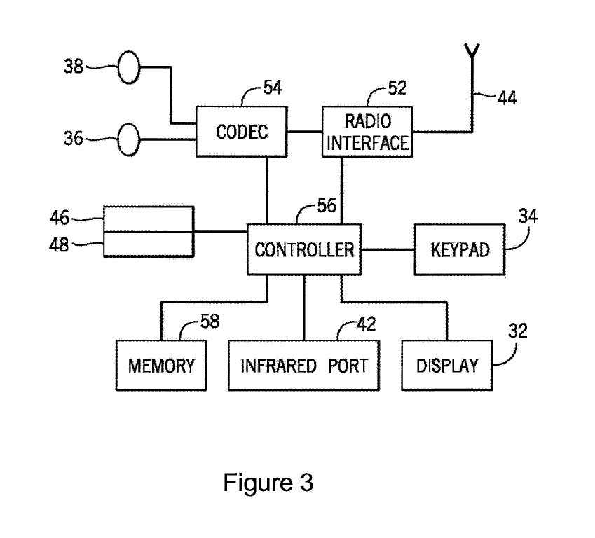

FIGS. 2 and 3 show one representative mobile telephone 12 within which the present invention may be implemented. It should be understood, however, that the present invention is not intended to be limited to one particular type of mobile telephone 12 or other electronic device. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

Software and web implementations of the present invention could be accomplished with standard programming techniques, with rule based logic, and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of generating a container file, comprising:
generating a set of packetization instructions for file delivery in one of the container file and a second file that is pointed to by the container file.

2. The method of claim 1, further comprising:
formatting the set of packetization instructions for file delivery as a hint track.

3. The method of claim 1, further comprising:
including an object in one of the container file and a third file that is pointed to by the container file; and
including in the set of packetization instructions for file delivery, a reference to the object.

4. The method of claim 3, wherein the object is a file.

5. The method of claim 3, further comprising:
formatting the set of packetization instructions for file delivery as a hint track; and
realizing the reference to the object as a constructor within a hint sample of the hint track.

6. A computer program product, embodied on a computer-readable medium, comprising computer code configured to perform the processes of claim 1.

7. An apparatus for generating a container file, comprising:
an electronic device configured to:
generate a set of packetization instructions for file delivery in one of the container file and a second file that is pointed to by the container file.

8. The apparatus of claim 7, wherein the electronic device is further configured to:
format the set of packetization instructions for file delivery as a hint track.

9. The apparatus of claim 7, wherein the electronic device is further configured to:
include an object in one of the container file and a third file that is pointed to by the container file; and
include in the set of packetization instructions for file delivery, a reference to the object.

10. The apparatus of claim 9, wherein the object is a file.

11. The apparatus of claim 9, wherein the electronic device is further configured to:
format the set of packetization instructions for file delivery as a hint track; and
realize the reference to the object as a constructor within a hint sample of the hint track.

12. A method of sending a file, comprising:
parsing a set of packetization instructions for file delivery from one of a container file and a second file that is pointed to by the container file;
forming data packets based on the set of packetization instructions for file delivery, the data packets facilitating reconstruction of the file; and
sending the data packets.

13. The method of claim 12, wherein the set of packetization instructions for file delivery are formatted as a hint track.

14. The method of claim 12, wherein an object is included in one of the container file and a third file that is pointed to by the container file, and wherein the object encloses the file and the set of packetization instructions for file delivery include a reference to the object.

15. The method of claim 14, wherein the set of packetization instructions for file delivery are formatted as a hint track, and wherein the reference to the object is realized as a constructor within a hint sample of the hint track.

16. A computer program product, embodied on a computer-readable medium, comprising computer code to perform the processes of claim 12.

17. An apparatus for sending a file, comprising:
an electronic device configured to:
parse a set of packetization instructions for file delivery from one of a container file and a second file that is pointed to by the container file;
form data packets based on the set of packetization instructions for file delivery, the data packets facilitating reconstruction of the file; and
send the data packets.

18. The apparatus of claim 17, wherein the set of packetization instructions for file delivery are formatted as a hint track.

19. The apparatus of claim 17, wherein an object is included in one of the container file and in a third file that is pointing to the container file, and wherein the object encloses the file and the set of packetization instructions for file delivery include a reference to the object.

20. The apparatus of claim 19, wherein the set of packetization instructions for file delivery are formatted as a hint track, and wherein the reference to the object is realized as a constructor within a hint sample of the hint track.
